(19) United States
(12) Patent Application Publication
(10) Pub. No.: US 2017/0031067 A1
(43) Pub. Date: Feb. 2, 2017

(54) MgF2 AND LIF AND RARE-EARTH FLUORIDE FILMS FOR ALUMINUM MIRRORS FOR FAR-ULTRAVIOLET SPECTRAL REGION AND METHOD OF MAKING SAME

(71) Applicant: U.S.A. as represented by the Administrator of the National Aeronautics and Space Administration, Washington, DC (US)

(72) Inventors: Manuel A. Quijada, Laurel, MD (US); Stephen H. Rice, Waldorf, MD (US)

(21) Appl. No.: 14/812,196

(22) Filed: Jul. 29, 2015

(51) Int. Cl. G02B 5/08; G02B 23/02; G02B 26/00; G02B 1/14

(52) U.S. Cl. CPC G02B 5/0858; G02B 5/0891; G02B 1/14; G02B 23/02; G02B 26/001

(57) ABSTRACT

The present invention relates to enhanced magnesium fluoride (MgF₂) and lithium fluoride (LiF) over-coated aluminum (Al) mirrors, for far-ultraviolet (FUV) spectral region, and a method of making same. In addition, the present invention relates to rare-earth fluorides such as gadolinium fluoride (GdF₂) and lutetium fluoride (LuF₃) films, which are used as high-index layers, that when paired with the lower index MgF₂, will provide multilayer coatings operable in the FUV spectral region.

### BACKGROUND OF THE INVENTION

1. Field of the Invention

The present invention relates to enhanced magnesium fluoride (MgF₂) and lithium fluoride (LiF) over-coated aluminum (Al) mirrors, for the far-ultraviolet (FUV) spectral region, and a method of making same. In addition, the present invention relates to rare-earth fluorides such as gadolinium fluoride (GdF₂) and lutetium fluoride (LuF₃) films, which are used as high-index layers, that when paired with the lower index MgF₂, will provide multilayer coatings operable in the FUV spectral region.

2. Description of the Related Art

Astronomical observations in the far-ultraviolet (FUV) spectral region are some of the more challenging due to the very distant and faint objects that are typically searched for in cosmic origin studies, such as the origin of large scale structures (i.e., the formation, evolution, and age of galaxies, and the origin of stellar and planetary systems). Many of the resonance lines for both low-ionization and high-ionization states of common atoms are found only or largely in the 90-180 nm region; thus, high-performance reflecting coatings in the 90-180 nm range are very important in instrumentation used in understanding the phenomena and processes associated with galaxy, stellar and planetary systems.

Some lines are found at wavelengths greater than 120 nm, but often their interpretation requires transitions with different oscillator strengths or different ionization states that are found in the FUV. Further, the electronic ground state transitions of hydrogen (H₂) are only found below 115 nm. Since hydrogen gas (H₂) is the most abundant molecule in the universe, and is the fundamental building block for star and planet formation, and the absorption lines of deuterium (D) and the molecule hydrogen deuteride (HD) are found only in the FUV region as well, the abundance of D is an important test of big band cosmology and of chemical evolution over cosmic time.

The region from 90-155 nm has not been extensively explored, and has been limited by a modest effective area reviewed (20 cm² below 100 nm to 55 cm² above 102 nm), and a modest spectral resolution (R 20,000). In spite of this, significant strides have been made in mapping variations in deuterium/hydrogen (D/H) in the galaxy, but they lacked the sensitivity to study D/H in the inter-galactic medium (IGM). This lack of sensitivity was due to low reflectance of the available coatings at FUV wavelengths, with the reflectively of conventional Al+LiF coatings being 50% at launch, while that of silicon carbide coatings (SiC) being about 30%. This low reflectivity in coatings used in current instruments was accommodated by employing only two optical surfaces, but the design had a number of shortcomings.

In particular, the coatings of choice for many of the space applications have been either magnesium fluoride (MgF₂) or lithium fluoride (LiF)-protected aluminum (Al+MgF₂ or Al+LiF). The principal reason is that in the ultraviolet spectral region above 100 nm, Al has the highest intrinsic reflectance of any known film material. While the natural formation of aluminum oxide degrades the reflectance below 200 nm, protective over-coatings of MgF₂ or LiF can extend the useful range down to their absorption cutoffs of 115 and 102.5 nm respectively. The thickness of either one was carefully selected to eliminate oxidation of the Al film while maintaining its excellent ultraviolet reflectance. This has made these coatings highly reliable coatings that have flown in space many times.

In a typical coating, the physical thickness of the MgF₂ is chosen to be 25 nm, which gives an optimized reflectance in reflectance at the short Lyman-alpha wavelength of 121.6 nm whereas a 40 nm MgF₂ layer is used for coatings optimized around 160 nm and above.

While these MgF₂ and LiF coatings have produced the highest reflectivity ever obtained (˜82% at 121.6 nm) it has always been noted that this is below the theoretical limit that could be achieved. This limitation has been attributed to the fact that either MgF₂ or LiF have a small but finite absorption due to deviation from pure crystalline form.

Further, prior art coatings had an efficiency of 60% or less, with prior art Al mirrors overprotected with a LiF layer overcoat being susceptible to humidity that quickly degraded reflectance performance to less than 20%. This lack of high-performing coatings in the eFUV has limited the astronomical observations that could be done in the 100-200 nm spectral range.

Accordingly, to maximize reflection and transmission of the thin film coating pair, it is important to produce a thin film of MgF₂ that is minimally absorbing in the FUV with a thickness of approximately a quarter of the operating wavelength in the 90-180 nm range. Improved reflectivity, particularly in the ultraviolet part of the spectrum, would bring enormous gains in throughput, and the benefits of more capable optical designs enabled by higher reflectivity would address any shortcomings noted above and thus, bring further gains in the sensitivity of instruments, and permit more instrument design freedom.

### SUMMARY OF THE INVENTION

The present invention relates to enhanced magnesium fluoride (MgF₂) and lithium fluoride (LiF) over-coated aluminum (Al) mirrors, for far-ultraviolet (FUV) spectral region, and a method of making same. In addition, the present invention relates to rare-earth fluorides such as gadolinium fluoride (GdF₂) and lutetium fluoride (LuF₃) films, which are used as high-index layers, that when paired with the lower index MgF₂, will provide multilayer coatings operable in the FUV spectral region.

In particular, the present invention relates to improvements in reflectance performance for low-absorption Al+MgF₂ and Al+LiF coatings in the FUV part of the optical spectrum (90-180 nm), which realizes the gain in throughput that can be obtained for a telescope system that would employ such mirror coatings. The coatings of the present invention have been optimized for Lyman-alpha wavelength (121.6 nm) or lower wavelengths, and were manufactured with a deposition of the MgF₂ or LiF layers done at elevated (˜250° C.) temperatures.

The present invention showed that improvements in the thermal evaporation process that produces MgF₂ with a factor of three (3) less absorption than films prepared in a conventional fashion. Similar gains can be achieved with Al mirrors over-coated with LiF layers which are also a material of choice for reflecting optics in the low end of the FUV spectral range. Uniformity of results in manufacturing the coatings in large (2-meter) chambers were also achieved with the methods of the present invention. Further, stainless steel shields in the chamber were wrapped in aluminum foil to quickly increase the temperature on the substrate in the third step.

In one embodiment, the use of these high-performing Al/LiF/MgF₂ coatings on mirror reflectors have yielded over 90% reflectance in the FUV spectral range, and have the potential to substantially increase the throughput of an optical system for astronomical observations in the 100-200 nm spectral range. In addition, the Al/LiF/MgF₂ coatings of the present invention are more environmentally stable than previous state-of-the-art coatings.

In one embodiment, rare-earth fluorides, such as GdF₃ and LuF₃, were found to have optical properties (refractive index n and absorption coefficient k) useful in producing multilayer coatings, on substrates (i.e., MgF₂ substrates), that would operate in the FUV spectral range. These materials may be good alternatives for use as high-index layers that, when paired with the lower index MgF₂, will enable production of multilayer coatings that could operate in the FUV spectral range. In one embodiment, GdF₃ and LuF₃ mirror coatings are deposited in the conventional two-step process of physical vapor deposition, and in the three step process of the present invention. Annealing was performed after the mirror coating was manufactured, in order to improve reflectivity at lower than 130 nm.

In one embodiment, a method of preparing a coating for use in reflective optics in the far ultraviolet spectral range, included: coating a first layer on a substrate at ambient temperature to a first predetermined thickness in a physical vapor deposition chamber greater than one meter; overcoating the first layer and the substrate with a relatively thin second layer in thickness in comparison to said first layer, at ambient temperature; heating the substrate with the first layer and the second layer, using shields wrapped with aluminum foil, to raise a temperature of the substrate to a maximum temperature greater than 200° C.; and overcoating the second layer, first layer and the substrate, with a third layer to a second predetermined thickness.

In one embodiment, the substrate is a magnesium fluoride substrate.

In one embodiment, the first layer is made from one of aluminum, lithium fluoride, gadolinium trifluoride or lutetium trifluoride.

In one embodiment, at least one of the second layer or the third layer is made from magnesium fluoride.

In one embodiment, the second layer and/or the third layer is made from one of gadolinium trifluoride or lutetium trifluoride.

In one embodiment, the relatively thin layer is 4 to 5 nm in thickness.

In one embodiment, a reflectance of the mirror coating is greater than 90%.

In one embodiment, the method further includes annealing said second layer and/or said third layer at about 300° C. for about 60 hours at a pressure of about 10⁻⁷ Torr, to increase reflectivity at wavelengths shorter than 130 nm.

In one embodiment, the method further includes rotating the substrate while using a coating baffle to deposit at least one of the first layer, second layer, or third layer, to reduce non-uniformity of thickness to less than 10%.

In one embodiment, a mirror coating for use in reflective optics in the far ultraviolet spectral range, includes: a first layer deposited on a substrate to a first predetermined thickness; a relatively thin second layer in thickness in comparison to the first layer, deposited on the first layer and the substrate to a second predetermined thickness; a third layer deposited on the second layer, first layer and the substrate, to a third predetermined thickness; wherein the first layer and the second layer were deposited at ambient temperature, and the third layer was deposited at a maximum temperature greater than 200° C.; and wherein shields wrapped in aluminum foil are used to heat the substrate to the maximum temperature, to deposit the third layer.

In one embodiment, the substrate is a magnesium fluoride substrate.

In one embodiment, the first layer is made from one of aluminum, lithium fluoride, gadolinium trifluoride or lutetium trifluoride.

In one embodiment, at least one of the second layer or the third layer is made from magnesium fluoride.

In one embodiment, the second layer and/or the third layer is made from one of gadolinium trifluoride or lutetium trifluoride.

In one embodiment, the relatively thin layer is 4 to 5 nm in thickness.

In one embodiment, the apparatus includes a rotating means to rotate the substrate; and a coating baffle which deposits at least one of the first layer, second layer, or third layer, to reduce non-uniformity of thickness to less than 10%.

In one embodiment, the mirror coating is used in one of a telescope system, or a Fabry-Perot tunable filter implemented in a thermospheric temperature imager.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is an exemplary graph which shows the absorption coefficient of thin MgF₂ films deposited onto LiF substrate at 22° C. (solid points) and 400° C. (solid triangles) as a function of photon energy.

FIG. 2 is an exemplary graph showing the reflectance of Al+MgF₂ mirror coatings in the FUV, according to one embodiment consistent with the present invention.

FIG. 3 is an exemplary graph of a comparison of an Al+LiF reflectance according to one embodiment consistent with the present invention, with the one produced in a conventional manner.

FIGS. 4A and 4B are exemplary graphs which show the transmittance and reflectance for LuF₃ (FIG. 4A) and GdF₃ (FIG. 4B) films, along with data for their respective substrates (MgF₂).

FIG. 5 is an exemplary graph which shows an extinction coefficient calculated from the data displayed in FIGS. 4A and 4B.

FIG. 6 is an exemplary graph which shows the refractive index derived from the data shown in FIGS. 4A and 4B.

FIG. 7 is an exemplary graph which shows a comparison of estimated throughput performance for a 2-mirror telescope system using a standard Al+MgF₂ coating, and a 4-mirror system with the Al+MgF₂ coating achieved according to embodiments consistent with the present invention.

### DESCRIPTION OF THE INVENTION

The present invention relates to enhanced magnesium fluoride (MgF₂) and lithium fluoride (LiF) over-coated aluminum (Al) mirrors, for far-ultraviolet (FUV) spectral region, and a method of making same. In addition, the present invention relates to rare-earth fluorides such as gadolinium fluoride (GdF₂) and lutetium fluoride (LuF₃) films, which are used as high-index layers, that when paired with the lower index MgF₂, will provide multilayer coatings operable in the FUV spectral region.

In one embodiment, the method of coating deposition used to produce the enhanced coatings process for Al and MgF₂ films, is a physical vapor deposition (PVD) process. In this exemplary process, a substrate (i.e., MgF₂) is placed inside a high-vacuum chamber, and the depositions are done using a resistive evaporation process where the source materials are placed in a resistive bowl (i.e., a molybdenum crucible) that is electrically connected to a high-current power supply to produce enough heat to boil and evaporate the materials. In one embodiment, a 2-m coating chamber equipped with PVD coating capabilities was used.

Pumping of the chamber is done with an oil-free closed-cycle cryo-pumped vacuum system to a pressure during the deposition of 1×10⁻⁶ Torr or lower. The vacuum is required to remove other vapor other than the source material, and allows the molecules to evaporate freely in the chamber, where they subsequently condense on the substrate surfaces.

The deposited thickness is controlled using a quartz crystal film thickness monitor to check the thickness, and a mechanical shutter to shut off the deposition once the desired thickness is achieved.

The coating chamber is equipped with halogen quartz lamp heaters and thermocouple sensors (to detect the temperature) attached to a copper block in contact with the substrate. The heaters and sensors are used whenever raising the temperature of the substrate during the film deposition is required. Stainless steel heat panels protect the coating chamber walls from contamination when the coating materials are evaporated.

In one embodiment, since the stainless steel shields absorb and dissipate heat, which requires a great deal of time and energy to raise the interior of the chamber to the desired temperature, a shroud or covering of aluminum foil is used to wrap the shields, and encompass an area around and above the optics being coated, the evaporation sources, and quartz lamp heaters, in order to relatively quickly (less than an hour) and uniformly heat the interior of the chamber to the target value of about 200° C., at lower heater power levels.

As is well-known in the art, factors that influence the purity of the deposited film are the quality of the vacuum, the purity of the source material, temperature of the substrate during deposition, and deposition rate. At a given vacuum pressure the film purity will be higher at higher deposition rates as this minimizes the relative rate of gaseous impurity inclusion. The thickness of the film will vary due to the geometry of the evaporation chamber and collisions with residual gases that aggravate thickness non-uniformity.

In one embodiment, a special coating baffle is used which permits more material to be deposited at the edge relative to the center (i.e., of a 0.5-meter radius substrate), and, in conjunction with rotating means to rotate the substrate, reduces non-uniformity of the thickness to less than 10% compared to as much as 50% non-uniformity if the substrate was held static.

In one embodiment, the transmittance and reflectance of the manufactured film is measured as a function of wavelength using a spectrometer, such as model No. VM-521-SG, manufactured by Acton Research Corporation (ARC). The ARC spectrometer is a one-meter high-vacuum monochromator designed to operate from 30 nm to 325 nm with a 1200 Grooves/mm grating. Effective coverage of the spectral range is dependent upon factors such as the optical coatings, grating efficiency, order-sorting filters, light source and detector. The spectrometer is equipped with a windowless hydrogen-purged light source, which provides discrete H₂ emission lines between 90 nm and 160 nm and a continuum above these wavelengths. The detector, which is housed inside a sample-holder compartment includes a photomultiplier cathode tube (PMT) connected to a light-pipe for feeding the light signal exiting the monochromator. The light pipe has a fluorescence and high quantum efficiency coating of sodium salicylate that is used to convert the FUV radiation into visible light. The maximum emission efficiency of this coating matches that of the PMT sensitivity curve that is close to 420 nm.

In one embodiment, measurements are performed by first measuring the total intensity coming from the monochromator into the detector housing with the sample out of the beam. The next measurement is made with the sample in the beam and this provides the energy transmitted or reflected by the sample. Proper normalization is done by taking the ratio of the reflected or transmitted energy through the sample by the total energy coming from the monochromator. The angle of incidence is set to 0° for the transmittance measurements, whereas for reflectance this is close to ˜12°.

Turning to the Al mirrors themselves, Al is the most reflective metal in the FUV region of the spectrum. However, a thin aluminum oxide (Al₂O₃) layer around 2-4 nm thick forms when bare Al is exposed to oxygen in the atmosphere. This thin layer is highly absorbing over much of the FUV region. This oxide layer is typically prevented from forming by applying a dielectric layer of either MgF₂ or LiF to the bare Al. The thickness of this dielectric layer is typically a quarter-wave of a wavelength in the 90-160 nm range. This thickness selection will provide a boost in reflectance at this design wavelength.

Contrary to conventional understanding that the higher the temperature of the substrate during deposition, the lower the absorption or extinction in the MgF₂ layer, experiments on Al+MgF₂ coatings heated up to the maximum temperature possible using the PVD coating chamber (˜220° C.), showed that the “hot” MgF₂ deposition has a worse or lower performance than deposition performed at ambient temperature. This result agreed with previous observations where the high reflectivity of Al film is degraded by heating it above 100° C. before the MgF₂ protection layer is applied. Some investigators assert that the Al reflectivity degradation is due to increased Al crystal grain size and surface roughness at high temperatures. However, others attribute the degradation to possible contamination of the Al layer due to increased contaminant and oxygen outgassing from the warm chamber walls. For example, contaminants such as hydrocarbons are highly absorbing in the FUV. In addition, oxygen will readily react with the Al layer to create aluminum oxide (Al₂O₃) which is highly absorbing at FUV wavelengths. Similar observations have been made that FUV reflectance is destroyed when unprotected films of Al are heated to high temperatures.

To summarize, in order to achieve a high reflecting Al coating in the FUV, the substrate must be cold (around room temperature) and in order to achieve a low absorption in the MgF₂ coating, the substrate must be hot.

In one embodiment, the present invention implements a multi-step process of vapor deposition of the Al film on a cold substrate, then heats the substrate, followed by depositing the MgF₂ onto the Al film on the now hot substrate. Since one must wait for the substrate to reach the hot temperature in the period between depositions of the Al and MgF₂ layers, which can cause oxidation and contamination of the fresh Al surface, and since the waiting period is expected to be significant and may be many hours, the present invention includes an additional step where a very thin layer of MgF₂ is coated immediately over the freshly deposited Al at room temperature, in order to protect it. In addition, this additional thin layer may inhibit the Al from forming large crystal grains that are less reflective. A protective overcoat of 4-5 nm would be the equivalent of slightly more than 10 monolayers.

Thus, Al mirrors over-coated with MgF₂ or LiF are among the material combination of choice for operation in the FUV spectral range. However, these mirror coatings also work well over a much broader range out to at least 2500 nm.

The three-step coating process of the present invention includes the following exemplary steps:

1) coating an initial Al layer (about 500 Å) on the substrate at room/ambient temperature to the planned layer thickness;

1) as soon as possible after the Al deposition (i.e., within an hour), overcoating the Al layer and substrate at room temperature with a thin (about 50 Å) layer of MgF₂ in order to protect the Al from oxidation and contamination;

2) heating the substrate using the series of heaters in the chamber, to raise the substrate temperature up to a maximum temperature of about 220° C., and overcoating the thin MgF₂ layer, the Al layer, and the substrate, with the planned thickness of MgF₂ (about 200 Å).

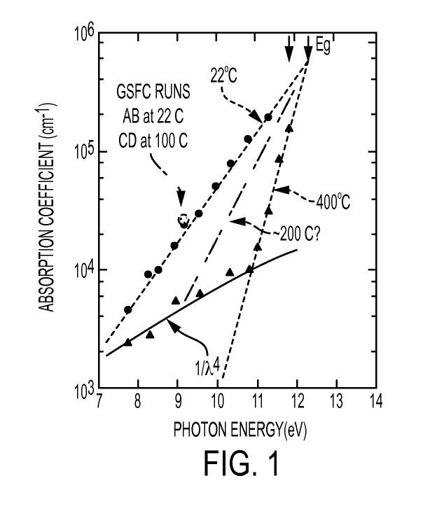

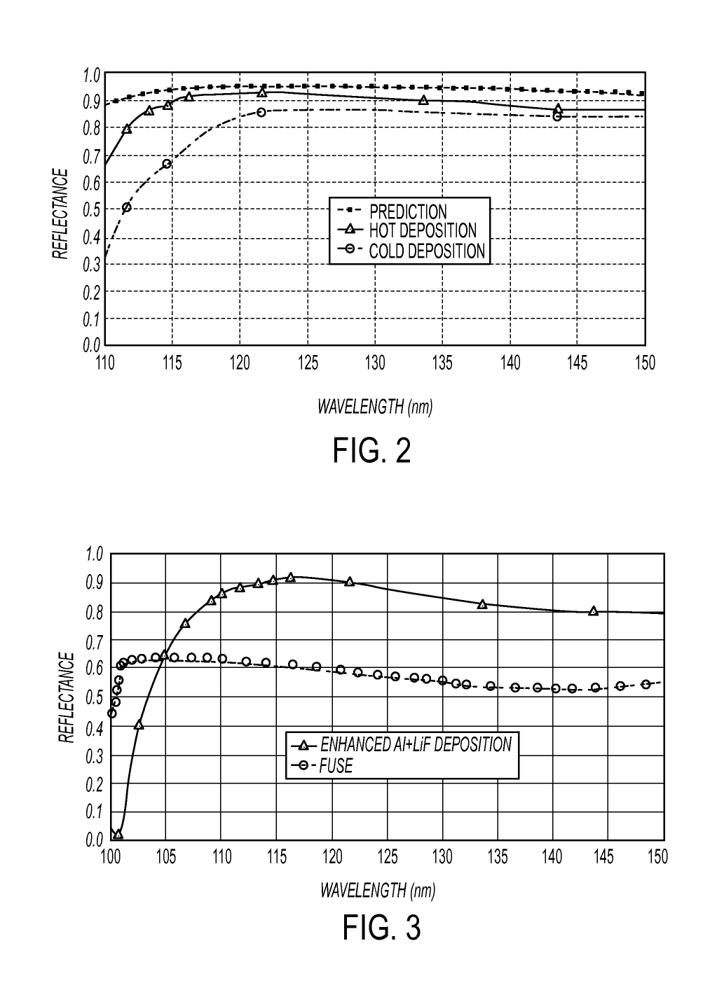

In order to determine the maximum temperature to achieve low absorption in the MgF₂ layer in step 3), previous conventional results show that a coating run at 22° C. had absorption for all photon energies between 104 nm (7 eV) and 178 nm (12 eV) (see FIG. 1). For the 135.6 nm wavelength of interest for a thermospheric temperature imager (TTI), the corresponding energy was 9.14 eV. The point labeled E_{g} in FIG. 2 is the MgF₂ energy gap, and it should be independent of the film deposition temperature. For intermediate temperatures, the absorption curve falls between the curves for 22° C. and 400° C. The black curve labeled 1/λ⁴ is due to the film surface roughness that scatters the light and it provides the limiting source of surface losses regardless of film quality.

Considering the 400° C. curve that is labeled 1/λ⁴ as the best lower limit that can be achieved for the MgF₂ coating, then the blue curve that has been overlaid on FIG. 1 is a reasonable estimate for the curve corresponding to the minimum temperature for the heated substrate in step 3) above of the coating process for a wavelength of 135.6 nm. Because this curve is approximately midway between the 22° C. and 400° C. curves, the required deposition temperature in step 3) of the present invention is expected to be greater than 200° C.

It is known that the average grain size of polycrystalline MgF₂ does not change significantly as a function of the deposition (growth) temperature up 100° C. At higher substrate temperatures, the MgF₂ grain size becomes significantly larger. Thus, the substrate deposition temperature needed to achieve a film grain size of 33 nm must be above 200° C. (600° K). Such a grain size would allow the entire thickness of the coating to be a single crystal. Consequently, the optimal substrate temperature in step 3) of the coating process of the present invention, for the wavelength of 135.6 nm should be in the range 200° C. to 323° C. (473° K to 600° K). Further, the thin layer may inhibit the Al from forming large crystal grains that are less reflective.

FIG. 2 is an exemplary graph which shows the results in reflectance of Al+MgF₂ mirror coatings in the FUV based on the above methods. In additional embodiments, more robust coatings provide substantial gain in throughput performance when the coatings are used on reflecting surfaces of FUV instrumentations. The results showed that reflectance reaches what would be predicted for bare Al at least at wavelengths close to 121.6 nm (91%). The results also indicate that the gains in reflectance for the methods of the present invention are even more dramatic on the short wavelength side, pushing the useful range even closer to the natural cut-off wavelength of crystalline MgF₂.

Although a suppression in the reflectance in the 140-180 nm wavelength range was noted, this is generally attributed to plasmonic absorption coupled with micro-roughness in the Al layer at those wavelengths.

In one embodiment, the micro-roughness of the Al+MgF₂ coatings prepared under ambient conditions, and where the MgF₂ layer was performed at temperatures as high as 250° C., were studied. Measurements were made using an surface profiler, such as the ADE Phase-Shift MicroXAM surface profiler, which is a phase-sensitive, interferometer-based, and non-contact instrument capable of providing highly reproducible surface mapping information at various magnification levels. The arrangement included an optical microscope with eyepieces and video display of images with a high resolution camera. The surface roughness parameters derived from the resulting images are shown in Table 1, as measured Peak-to-Valley (PV) and root-mean-square (Sq) micro-roughness parameters for two Al+MgF₂ 2×2 inch test coupons prepared with ambient and hot MgF₂ depositions.

TABLE 1

| | |
|---|---|
| Ambient | Hot |

| | PV (Å) | Sq(Å) | PV (Å) | Sq(Å) |
|---|---|---|---|---|
| top left | 75.6 | 6.15 | 45.3 | 2.25 |
| top right | 101.2 | 5.20 | 40.2 | 2.33 |
| Center | 128.0 | 4.02 | 51.0 | 3.30 |
| bottom left | 200.1 | 3.03 | 44.4 | 2.92 |
| bottom right | 100.0 | 3.28 | 50.8 | 3.85 |
| Average | 120.97 | 4.33 | 46.3 | 2.93 |

The exemplary results in Table 1 show that the Peak-to-Valley numbers for the “Ambient” sample are approximately 2-3 times larger than for the “Hot” one. This observation suggests the heating may provide a flatter surface profile by perhaps reducing the stress-induced effects of the MgF₂ films. The test mirror that was heated during the MgF₂ deposition has a 30% smaller average RMS micro-roughness parameter (Sq), suggesting a larger grain size for this sample.

Thus, in one embodiment, the above steps achieve an Al coating with higher reflectance at FUV wavelengths, by requiring the substrate to be cold (around room temperature), and in order to achieve a low absorption in the metal-fluoride coating, the substrate must be hot. In additional, the waiting period for the substrate to reach the hot temperature in between depositions of Al and metal-fluoride layers will produce oxidation and contamination of the fresh Al surface. Thus, the additional step of adding a very thin layer (about 5 nm) of the metal-fluoride over the freshly deposited Al in order to protect it, is advantageous. In addition, grain size is more uniform and micro-roughness is reduced, with corresponding threefold less absorption than films prepared in a conventional manner. In addition, with the large 2-m chamber, uniformity of results in the coatings was achieved compared to smaller chambers.

In one embodiment, similar gains have been produced on Al mirrors overcoated with LiF layers, which is also a material of choice for reflecting optics in the low end of the FUV spectral range.

With respect to Al+LiF coatings manufactured using the above disclosed three-step process, exemplary results are depicted in FIG. 3, along with a representative curve from a conventional mirror coating used in an instrument prior to space launch. The coating parameters for the Al+LiF sample achieved through the three-step process included an Al layer (430 Å), followed by 80 Å of LiF in the second step. The sample was then heated and kept at 250° C. during the final LiF layer deposition of 164 Å for a total thickness of 244 Å. The data in FIG. 3 shows the reflectance values achieved according to the methods of the present invention, are over 90% in the 110-125 nm range. This represents the highest ever reported reflectance for Al+LiF coatings in this wavelength range.

As shown in the exemplary graph of FIG. 3, the conventional methods are still higher below 105 nm when compared to the sample prepared according to the present methods, but this is explained by the fact that the total LiF thickness (244 Å) was too large to produce enhancements at those lower wavelengths. However, from the results, it is clear that using the present methods, enhanced LiF coatings that approach the theoretical limit based on the optical constants for crystalline LiF can be prepared. In addition, overcoat layers of either LiF or MgF₂ are significantly improved and reflectivity increased at wavelengths shorter than 130 nm by an additional step of annealing the deposited films at about 300° C. for some 60 hours at a pressure of about 10⁻⁷ Torr, using a heater build onto the substrate holder.

Accordingly, considerable gains in FUV reflectivity of Al+MgF₂ and Al+LiF mirrors have been achieved by employing the exemplary three-step process of the present invention, during PVD coating deposition of these materials. The present invention includes superior results with a larger 2-meter chamber, which allows coating optics much larger than a 1-meter chamber. In addition, shortening the time to heat the substrate and adding an annealing step, contribute to the high reflectance of the coatings.

Accordingly, the use of the high-performing Al/LiF/MgF₂ coatings of the present invention, on mirror reflectors, have yielded over 90% reflectance in the FUV spectral range, and have the potential to substantially increase the throughput of an optical system for astronomical observations in the 100-200 nm spectral range. In addition, the Al/LiF/MgF₂ coatings of the present invention are more environmentally stable than previous state-of-the-art coatings.

In one embodiment, rare-earth fluorides, such as GdF₃ and LuF₃, have been used to determine whether their optical properties (refractive index n and absorption coefficient k) would be useful in producing multilayer coatings, on substrates (i.e., MgF₂ substrates), that would operate in the FUV spectral range. It is known that the n values for GdF₃ and LuF₃ are higher than MgF₂ in the 250-600 nm spectral range, and that their transparency could extend to much lower wavelengths due to their large bandgap energy. Thus, these materials may be good alternatives for use as high-index layers that, when paired with the lower index MgF₂, will enable production of multilayer coatings that could operate in the FUV spectral range.

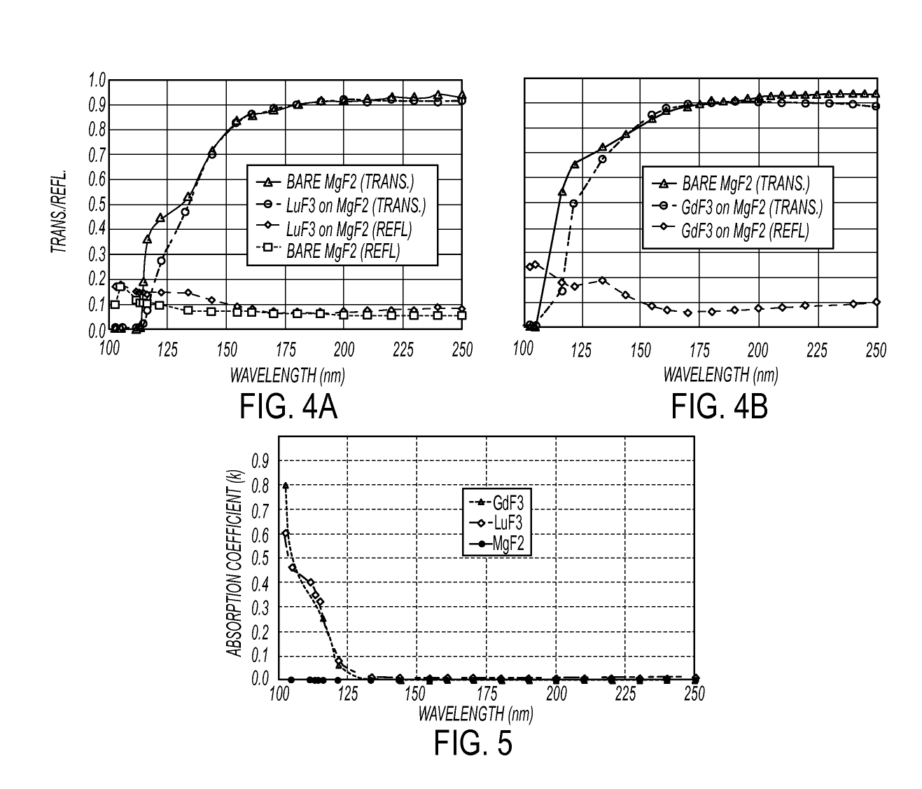

FIGS. 4A and 4B are exemplary graphs which show the transmittance and reflectance for LuF₃ (FIG. 4A) and GdF₃ (FIG. 4B) films, along with data for their respective substrates (MgF₂). Note that the bare MgF₂ was measured prior to depositing the LuF₃ and GdF₃ films on the respective substrates, in order to characterize the films' properties as accurately as possible, since variation in the transmission of the bare MgF₂ substrates before the LuF₃ and GdF₃ films are deposited, is known (see FIGS. 4A and 4B). The methods of deposition are performed according to the conventional two step method of PVD. This involved depositing the LuF₃ or GdF₃ layer on the MgF₂ substrate at ambient temperature to the planned thickness, and then depositing the LuF₃ or GdF₃ layer at the elevated temperature (i.e., greater than 200° C.) noted above.

In one embodiment, the additional step of overcoating the LuF₃ or GdF₃ layer and substrate at room temperature with a thin (4-5 nm) layer of MgF₂ can be implemented, before the substrate is heated to the maximum temperature.

Exemplary results of the transmission data for the LuF₃ and GdF₃ films show that their transparency (or k=0) range may indeed extend to wavelengths close to the lower limits shown in FIGS. 4A and 4B.

Thus, FIGS. 4A and 4B provide the basis to determine the optical constants of the LuF₃ and GdF₃ films grown on MgF₂ substrates. This is done by fitting the data to the Fresnel equations, and by solving for n( [symbol] ) and k( [symbol] ) from the measured transmittance (T [symbol] )) and reflectance (R( [symbol] )) values. A root-finding numerical solution was utilized, and results of the calculations are shown in the graph of FIG. 5, where k( [symbol] ) is shown for the LuF₃ and GdF₃ films, and the MgF₂ substrate.

FIG. 5 is an exemplary graph which clearly shows that the onset of absorption for LuF₃ and GdF₃ starts below 130 nm. Therefore, the use of either one of them as a high-index alternative for a dielectric design is feasible for wavelengths longer than 130 nm. Further, k values for MgF₂ remain nearly zero over the range shown. This is because the material has a lower cut-off wavelength, and that these data were derived from measurements on a crystalline MgF₂ piece of substrate that is more likely to have bulk properties than either of the LuF₃ and GdF₃ films.

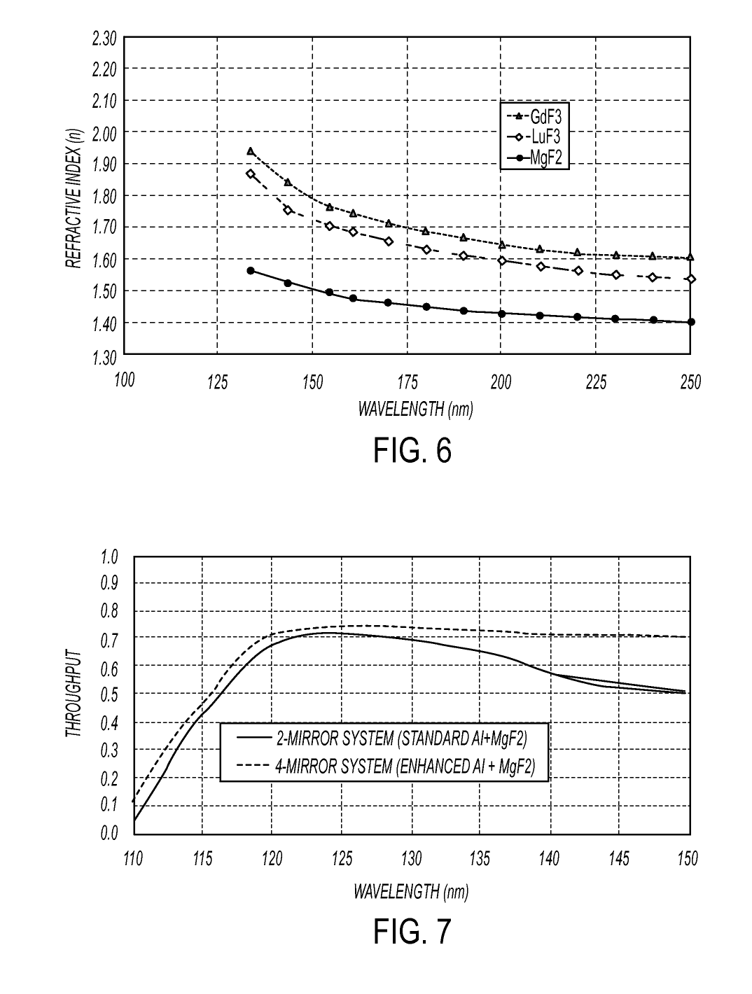

FIG. 6 is an exemplary graph which shows n( [symbol] ) for GdF₃ and LuF₃, along with the results for the MgF₂ substrates. FIG. 6 shows that the index values get progressively higher in the 130-250 nm range, starting with MgF₂ (n˜1.60-1.40), followed by LuF₃ (n˜1.80-1.52), and finally GdF₃ (n˜1.95-1.60). The combination of the GdF₃/MgF₂ pair will provide a greater contrast in their respective refractive index values that will have the greater potential for a successful dielectric design in the 130-250 spectral range with fewer layers.

Accordingly, from the results above, GdF₃ and LuF₃ are suitable as high-refractive index components in multilayer interference stacks. Due to their wide band-gap, the onset of absorption occurs at wavelengths shorter than 130 nm. Thus, they provide a suitable alternative for the fabrication of interference filters that will operate in the FUV optical spectrum.

Accordingly, improved reflective coatings as achieved by the present invention, particularly in the far ultraviolet (FUV) part of the spectrum, will yield dramatically more sensitive instruments and permit more instrument design freedom, particularly for space applications. Increasing system throughput is a very cost effective way to achieve more science and often is less costly than simply using a larger primary mirror.

Increasing system throughput is demonstrated by the exemplary results in FIG. 7, where the calculated throughput for a 2-mirror telescope system employing the conventional Al+MgF₂ coating process, and a 4-mirror system using the improved reflectance of the Al+MgF₂ coatings produced according to the methods of the present invention, were compared. Even though the throughput for the 4-mirrors system is a bit lower, it still provides acceptable etendue. Further, since previously, 4-bounce systems were too low in throughput for serious consideration, the results illustrate that the advantages of having better performing coatings as shown by the present invention, adds more flexibility to a system design that is certain to improve overall performance.

Thus, the present invention's advantage is that the coatings produced will have a 30% increase in throughput, which has the potential to more than double the efficiency of an optical system for cosmological observations in the FUV optical spectrum. The present technology will enable the production of Al mirrors with a low micro-roughness. This will produce reflectors with a low scatterer.

The coatings of the present invention can be realized, for example, in a Fabry-Perot tunable filter implemented in a thermospheric temperature imager (TTI) used in a satellite, to carry out global-scale remote measurements of the thermospheric temperature profile of atomic oxygen from low earth orbit. The inner cavity walls of the FPI can be coated with a thin Al+MgF₂ coating, for example, that provides 90% reflectance and about 6% transmission in the 130-140 nm range. These results show that improvements in the thermal evaporation process produced MgF₂ films with a factor of three (3) less absorption than films prepared in a conventional fashion. Similar gains have been shown to be possible on Al mirrors over-coated with LiF layers which are also a material of choice for reflecting optics FUV instrumentation. Finally, GdF₃ and LuF₃ are also suitable as high-refractive index components in multilayer films used in optics in the FUV spectral range.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of preparing a mirror coating for use in reflective optics in the far ultraviolet spectral range, comprising:
coating a first layer on a substrate at ambient temperature to a first predetermined thickness in a physical vapor deposition chamber greater than one meter;
overcoating said first layer and said substrate with a second layer relatively thin in thickness in comparison to said first layer, at ambient temperature;
heating said substrate with said first layer and said second layer, using shields wrapped with aluminum foil, to raise a temperature of said substrate to a maximum temperature greater than 200° C.; and
overcoating said second layer, said first layer and said substrate, with a third layer to a second predetermined thickness.

2. The method of claim 1, wherein said substrate is a magnesium fluoride substrate.

3. The method of claim 2, wherein said first layer is made from one of aluminum, lithium fluoride, gadolinium trifluoride or lutetium trifluoride.

4. The method of claim 2, wherein at least one of said second layer or said third layer is made from magnesium fluoride.

5. The method of claim 3, wherein said second layer and/or said third layer is made from one of gadolinium trifluoride or lutetium trifluoride.

6. The method of claim 1, wherein said second layer is 4 to 5 nm in thickness.

7. The method of claim 5, further comprising:
annealing said second layer and/or said third layer at about 300° C. for about 60 hours at a pressure of about 10⁻⁷ Torr, to increase reflectivity at wavelengths shorter than 130 nm.

8. The method of claim 1, further comprising:
rotating said substrate while using a coating baffle to deposit said at least one of said first layer, second layer, or third layer, to reduce non-uniformity of thickness to less than 10%.

9. The method of claim 1, wherein a reflectance of the mirror coating is greater than 90%.

10. A mirror coating for use in reflective optics in the far ultraviolet spectral range, comprising:
a first layer deposited on a substrate to a first predetermined thickness;
a second layer relatively thin in thickness in comparison to said first layer, deposited on said first layer and said substrate to a second predetermined thickness;
a third layer deposited on said second layer, first layer and said substrate, to a third predetermined thickness;
wherein said first layer and said second layer were deposited at ambient temperature, and said third layer was deposited at a maximum temperature greater than 200° C.; and
wherein shields wrapped in aluminum foil are used to heat said substrate to said maximum temperature, to deposit said third layer.

11. The apparatus of claim 10, wherein said substrate is a magnesium fluoride substrate.

12. The apparatus of claim 11, wherein said first layer is made from one of aluminum, lithium fluoride, gadolinium trifluoride or lutetium trifluoride.

13. The apparatus of claim 12, wherein at least one of said second layer or said third layer is made from magnesium fluoride.

14. The apparatus of claim 12, wherein said second layer and/or said third layer is made from one of gadolinium trifluoride or lutetium trifluoride.

15. The apparatus of claim 10, wherein said second layer is 4 to 5 nm in thickness.

16. The apparatus of claim 10, wherein a reflectance of the mirror coating is greater than 90%.

17. The apparatus of claim 10, further comprising:
a rotating means to rotate said substrate; and
a coating baffle which deposits said at least one of said first layer, second layer, or third layer, to reduce non-uniformity of thickness to less than 10%.

18. The apparatus of claim 10, wherein the mirror coating is used in one of a telescope system, or a Fabry-Perot tunable filter implemented in a thermospheric temperature imager.
